(19) United States
(12) Patent Application Publication
(10) Pub. No.: US 2005/0172253 A1
(43) Pub. Date: Aug. 4, 2005

(54) Automatic placement and routing device, method for placement and routing of semiconductor device, semiconductor device and manufacturing method of the same

(75) Inventor: Ayumu Osanai, Kanagawa (JP)

Correspondence Address: FOLEY AND LARDNER;SUITE 500, 3000 K STREET NW, WASHINGTON, DC, 20007, US

(73) Assignee: NEC Electronics Corporation

(21) Appl. No.: 11/041,995

(22) Filed: Jan. 26, 2005

(30) Foreign Application Priority Data
Jan. 30, 2004 (JP) 2004-024602

(51) Int. Cl. G06F 17/50

(52) U.S. Cl. 716/10; 716/12; 716/13; 716/5

(57) ABSTRACT

A method of placement and routing of a semiconductor device, includes steps (a) to (c). The step (a) is a procedure of executing placement of functional blocks and executing routing of interconnections in a placement and routing area of a semiconductor device based on circuit diagram data, functional block data and design rule data. The step (b) is a procedure of executing placement of spare cells in first areas of the placement and routing area, disregarding the routing result, wherein the functional blocks are not placed in the first areas, the spare cells are spare functional blocks. The step (c) is a procedure of removing first spare cells of the spare cells from the first areas, wherein the first spare cells are in violation of a design rule with regard to a relation to the interconnections, the design rule is described in the design rule data.

### BACKGROUND OF THE INVENTION

1. Field of the Invention

The present invention relate to an automatic placement and routing device, a method of placement and routing of a semiconductor device, a semiconductor device and a manufacturing method of the same. More particularly, the present invention relates to those devices and methods which are improved in an efficiency of the designing semiconductor devices.

2. Description of the Related Art

In a layout design of a large-scale integration (LSI), an automatic placement and routing system is known, in which placing functional blocks and the routing are carried out automatically. In the following description, both of a (logic) functional cell and a (logic) functional block are referred to as a functional block. A computer having a CAD (Computer Aided Design) software exemplifies the automatic placement and routing device. A placement and routing using the automatic placement and routing device is carried out, for instance, as follows. First of all, the automatic placement and routing device read data of circuit diagrams of designing objective LSI, data of functional blocks prepared as a library, and data of design rules. Then, the automatic placement and routing device places the functional blocks based on the read data. Afterwards, the automatic placement and routing device performs routing with regard to the functional blocks based on the read data. After that, the automatic placement and routing device verifies whether or not there is a problem in the placement and routing, and carries out re-placement and re-routing if necessary. Finally, data of the automatic placement and routing device is generated as an artwork data concerning routing of entire chip corresponding to patterns of layers composing the LSI. The functional blocks, which are automatically placed, include functional blocks directly used for realizing circuit functions and spare cells. The spare cell exemplifies a fill cell with a gate cap and a phantom cell. The fill cell exemplifies a voltage source capacity for power supply noise reduction. The phantom cells are placed dispersedly in advance, preparing for design change. In a conventional process, the functional blocks, which are directly used for realizing the circuit function, are firstly placed. Next, the above-mentioned spare cells are placed. Then, the routing required for realizing the circuit functions is carried out. In this case, most of the spare cells are simple figures. However, since the number of the spare cells is huge, the spare cells give a load to the routing tool of the automatic placement and routing device. This causes that time required for designing (TAT: Turn Around Time) and memory capacity required for designing are increased. In addition, some patterns of the spare cells affect the routing efficiency. Therefore, it may be expected that the routing efficiency be reduced by placing the spare cells before routing which should be prioritized.

Techniques are desired which can reduce the load of routing tool, the memory capacity required for designing, and the TAT for designing. Moreover, technique is desired which can improve the routing properties.

In conjunction with the above description, Japanese Laid Open Patent Application (JP 2001-284456A) discloses a technique of a method of the placement and routing. This invention has aimed to provide a placement and routing method for an efficient placement of spare cells on the remained area after a placement and routing of standard cells.

This method designs the placement and routing of the standard cells on a placement and routing area corresponding to a circuit forming area on a semiconductor chip. Dummy cells and spare cell columns are prepared therein. Here, dimensions of the dummy cells are defined, but circuits to be placed on them are not defined. In the spare cell columns, the circuits to be placed on the dummy cells are defined. Then, a plurality of the standard cells is placed on the placement and routing area so as to satisfy general and predetermined functions. Afterward, the dummy cells are placed on the remained area, of which sizes are larger than those of the dummy cells, after the placement of the standard cells are executed. Finally, the placed dummy cells are substituted the spare cell columns.

### SUMMARY OF THE INVENTION

Therefore, an object of the present invention is to provide an automatic placement and routing device and a method of placement and routing of a semiconductor device, which can places spare cells while reducing the load of routing tool and the memory capacity required for designing, and also provide a semiconductor device and a manufacturing method of the same to which the method of placement and routing of a semiconductor device are applied.

Another object of the present invention is to provide an automatic placement and routing device and a method of placement and routing of a semiconductor device, which can executes the most appropriate routing while not being affected by spare cells, and also provide a semiconductor device and a manufacturing method of the same to which the method of placement and routing of a semiconductor device are applied.

Still another object of the present invention is to provide an automatic placement and routing device and a method of placement and routing of a semiconductor device, which can improve a efficiency of designing of a semiconductor device, and also provide a semiconductor device and a manufacturing method of the same to which the method of placement and routing of a semiconductor device are applied.

This and other objects, features and advantages of the present invention will be readily ascertained by referring to the following description and drawings.

In order to achieve an aspect of the present invention, the present invention provides a method of placement and routing of a semiconductor device, including: (a) executing placement of functional blocks and executing routing of interconnections in a placement and routing area of a semiconductor device based on circuit diagram data, functional block data and design rule data; (b) executing placement of spare cells in first areas of the placement and routing area, disregarding the routing result, wherein the functional blocks are not placed in the first areas, the spare cells are spare functional blocks; and (c) removing first spare cells of the spare cells from the first areas, wherein the first spare cells are in violation of a design rule with regard to a relation to the interconnections, the design rule is described in the design rule data.

In the method of placement and routing of a semiconductor device, the spare cells may include at least one of a fill cell and a phantom cell.

The method of placement and routing of a semiconductor device may further include: (d) verifying a situation of the placement and routing area based on the circuit diagram data, the functional block data and the design rule data; (e) executing corrections of defects in second areas of the placement and routing area, when the defects are found in the second areas during the verification; (f) re-executing placement of other functional blocks and re-executing routing of other interconnections in the second areas; (g) executing placement of other spare cells in third areas of the second areas, disregarding the re-executed routing result, wherein the other functional blocks are not placed in the third areas, the other spare cells are spare functional blocks; and (h) removing second spare cells of the other spare cells from the third areas, wherein the second spare cells are in violation of the design rule with regard to a relation to the other interconnections.

The method of placement and routing of a semiconductor device may further include: (d) verifying a situation of the placement and routing area based on the circuit diagram data, the functional block data and the design rule data; (e) executing corrections of defects in second areas of the placement and routing area, when the defects are found in the second areas during the verification; (f) re-executing placement of other functional blocks and re-executing routing of other interconnections in the second areas; (g) executing placement of other spare cells in third areas of the second areas, disregarding the re-executed routing result, wherein the other functional blocks are not placed in the third areas, the other spare cells are spare functional blocks; and (h) removing second spare cells of the other spare cells from the third areas, wherein the second spare cells are in violation of the design rule with regard to a relation to the other interconnections.

In order to achieve another aspect of the present invention, the present invention provides an automatic placement and routing device including: an automatic placement and routing section, a spare cell placement section and a spare cell verification section. The automatic placement and routing section executes placement of functional blocks and executes routing of interconnections in a placement and routing area of a semiconductor device based on circuit diagram data, functional block data and design rule data. The spare cell placement section executes placement of spare cells in first areas of the placement and routing area, disregarding the routing result. The functional blocks are not placed in the first areas, the spare cells are spare functional blocks. The spare cell verification section removes first spare cells of the spare cells from the first areas. The first spare cells are in violation of a design rule with regard to a relation to the interconnections. The design rule is described in the design rule data.

In the automatic placement and routing device, the spare cells may include at least one of a fill cell and a phantom cell.

The automatic placement and routing device, the spare cell verification section may verify a situation of the placement and routing area based on the circuit diagram data, the functional block data and the design rule data. In this case, the spare cell verification section executes corrections of defects in second areas of the placement and routing area, when the defects are found in the second areas during the verification. The spare cell verification section re-executes placement of other functional blocks and re-executes routing of other interconnections in the second areas. The spare cell placement section executes placement of other spare cells in third areas of the second areas, disregarding the re-executed routing result. The other functional blocks are not placed in the third areas. The other spare cells are spare functional blocks. The spare cell verification section removes second spare cells of the other spare cells from the third areas. The second spare cells are in violation of the design rule with regard to a relation to the other interconnections.

The automatic placement and routing device, the spare cell verification section may verify a situation of the placement and routing area based on the circuit diagram data, the functional block data and the design rule data. In this case, the spare cell verification section executes corrections of defects in second areas of the placement and routing area, when the defects are found in the second areas during the verification. The spare cell verification section re-executes placement of other functional blocks and re-executes routing of other interconnections in the second areas. The spare cell placement section executes placement of other spare cells in third areas of the second areas, disregarding the re-executed routing result. The other functional blocks are not placed in the third areas. The other spare cells are spare functional blocks. The spare cell verification section removes second spare cells of the other spare cells from the third areas. The second spare cells are in violation of the design rule with regard to a relation to the other interconnections.

In order to achieve still another aspect of the present invention, the present invention provides a computer program product embodied on a computer-readable medium and including code that, when executed, causes a computer to perform the following: (a) executing placement of functional blocks and executing routing of interconnections in a placement and routing area of a semiconductor device based on circuit diagram data, functional block data and design rule data; (b) executing placement of spare cells in first areas of the placement and routing area, disregarding the routing result, wherein the functional blocks are not placed in the first areas, the spare cells are spare functional blocks; and (c) removing first spare cells of the spare cells from the first areas, wherein the first spare cells are in violation of a design rule with regard to a relation to the interconnections, the design rule is described in the design rule data.

In the computer program product, the spare cells may include at least one of a fill cell and a phantom cell.

The computer program product may further include: (d) verifying a situation of the placement and routing area based on the circuit diagram data, the functional block data and the design rule data; (e) executing corrections of defects in second areas of the placement and routing area, when the defects are found in the second areas during the verification; (f) re-executing placement of other functional blocks and re-executing routing of other interconnections in the second areas; (g) executing placement of other spare cells in third areas of the second areas, disregarding the re-executed routing result, wherein the other functional blocks are not placed in the third areas, the other spare cells are spare functional blocks; and (h) removing second spare cells of the other spare cells from the third areas, wherein the second spare cells are in violation of the design rule with regard to a relation to the other interconnections.

The computer program product may further include: (d) verifying a situation of the placement and routing area based on the circuit diagram data, the functional block data and the design rule data; (e) executing corrections of defects in second areas of the placement and routing area, when the defects are found in the second areas during the verification; (f) re-executing placement of other functional blocks and re-executing routing of other interconnections in the second areas; (g) executing placement of other spare cells in third areas of the second areas, disregarding the re-executed routing result, wherein the other functional blocks are not placed in the third areas, the other spare cells are spare functional blocks; and (h) removing second spare cells of the other spare cells from the third areas, wherein the second spare cells are in violation of the design rule with regard to a relation to the other interconnections.

In order to achieve yet still another aspect of the present invention, the present invention provides a manufacturing method of a semiconductor device, including: (a) obtaining a layout design of a semiconductor device by a method of placement and routing of the semiconductor device; and (b) manufacturing the semiconductor device by using masks produced by using the layout design. The method of placement and routing of the semiconductor device, includes: (a1) executing placement of functional blocks and executing routing of interconnections in a placement and routing area of a semiconductor device based on circuit diagram data, functional block data and design rule data; (a2) executing placement of spare cells in first areas of the placement and routing area, disregarding the routing result, wherein the functional blocks are not placed in the first areas, the spare cells are spare functional blocks; and (a3) removing first spare cells of the spare cells from the first areas, wherein the first spare cells are in violation of a design rule with regard to a relation to the interconnections, the design rule is described in the design rule data.

In the manufacturing method of a semiconductor device, the spare cells may include at least one of a fill cell and a phantom cell.

In the manufacturing method of a semiconductor device, the method of placement and routing of the semiconductor device may further include: (a4) verifying a situation of the placement and routing area based on the circuit diagram data, the functional block data and the design rule data; (a5) executing corrections of defects in second areas of the placement and routing area, when the defects are found in the second areas during the verification; (a6) re-executing placement of other functional blocks and re-executing routing of other interconnections in the second areas; (a7) executing placement of other spare cells in third areas of the second areas, disregarding the re-executed routing result, wherein the other functional blocks are not placed in the third areas, the other spare cells are spare functional blocks; and (a8) removing second spare cells of the other spare cells from the third areas, wherein the second spare cells are in violation of the design rule with regard to a relation to the other interconnections.

In the manufacturing method of a semiconductor device, the method of placement and routing of the semiconductor device may further include: (a4) verifying a situation of the placement and routing area based on the circuit diagram data, the functional block data and the design rule data; (a5) executing corrections of defects in second areas of the placement and routing area, when the defects are found in the second areas during the verification; (a6) re-executing placement of other functional blocks and re-executing routing of other interconnections in the second areas; (a7) executing placement of other spare cells in third areas of the second areas, disregarding the re-executed routing result, wherein the other functional blocks are not placed in the third areas, the other spare cells are spare functional blocks; and (a8) removing second spare cells of the other spare cells from the third areas, wherein the second spare cells are in violation of the design rule with regard to a relation to the other interconnections.

### BRIEF DESCRIPTION OF THE DRAWINGS

FIG. 1 is a view showing the configuration of the embodiment of the automatic placement and routing device according to the present invention;

FIG. 2 is a view showing an example of the placement and routing area used in the embodiment of the method of placement and routing of the semiconductor device according to the present invention;

FIGS. 3A, 3B and 3C are pattern diagrams showing examples of the functional blocks;

FIG. 4 is a pattern diagram showing the state of the placement and routing area, which corresponds to the step S02 in FIG. 8;

FIG. 5 is a pattern diagram showing the state of the placement and routing area, which corresponds to the step S03 in FIG. 8;

FIG. 6 is a pattern diagram showing the state of the placement and routing area, which corresponds to the step S04 in FIG. 8;

FIG. 7 is a pattern diagram showing the state of the placement and routing area, which corresponds to the step S05 in FIG. 8;

FIG. 8 is a flowchart showing the embodiment of the method of the placement and routing of the semiconductor device according to the present invention;

FIG. 9 is a pattern diagram showing the state of the placement and routing area, which corresponds to the step S04 in FIG. 8;

FIG. 10 is a pattern diagram showing the state of the placement and routing area, which corresponds to the step S05 in FIG. 8; and

FIG. 11 is a flowchart showing the embodiment of the manufacturing method of the semiconductor device according to the present invention.

### DESCRIPTION OF THE PREFERRED EMBODIMENTS

Embodiments of an automatic placement and routing device, a method of the placement and routing in the semiconductor device, a manufacturing method of the semiconductor device of the present invention will be described below with reference to the attached drawings. It should be noted that both of a (logic) functional cell and a (logic) functional block are referred to as a functional block in following specification.

Firstly, a configuration of the embodiment of the automatic placement and routing device of the present invention, to which the method of the placement and routing of the semiconductor device is applied, will be described with reference to the attached drawings.

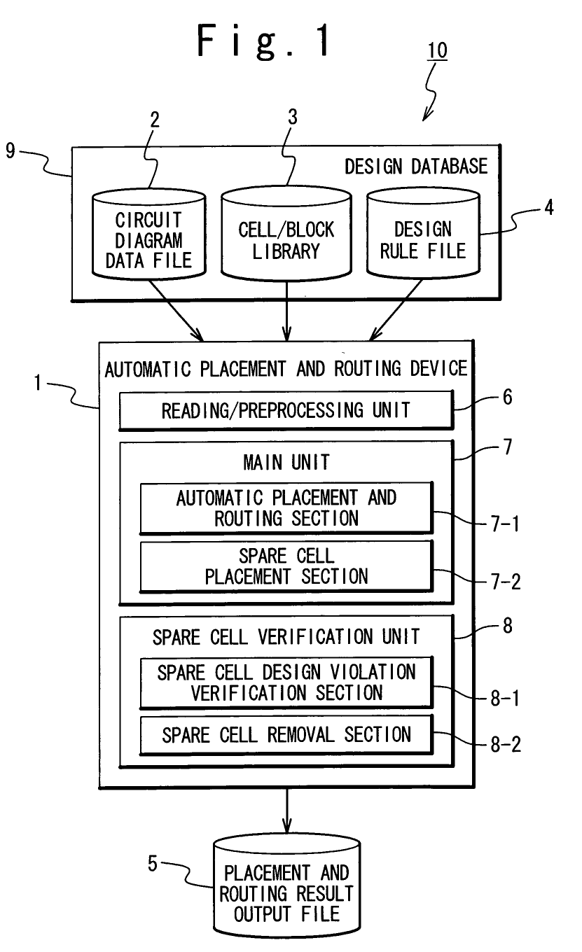

FIG. 1 is a view showing the configuration of the embodiment of the automatic placement and routing device according to the present invention. A placement and routing system 10 includes an automatic placement and routing device 1 and a design database 9.

The design database 9 is an information processor such as a workstation and a personal computer. The design database 9 includes a circuit diagram data file 2, a cell/block library 3, and a design rule file 4, which are data and computer programs related to the data. The circuit diagram data file 2 includes circuit diagram data with connection data. The circuit diagram data show circuit diagrams. The connection data show how terminals of blocks included in the objective LSI for design are connected with each other. The cell/block library 3 includes functional block data (cell/block data). The functional block data show data regarding a (logic function) cell/block such as a via cell, a NAND gate and a circuit to realize complex logic functions. The design rule file 4 includes design rule data, which are used in processes of placement, routing and verifying, such as a routing pitch, a routing width, a minimum routing pitch of each routing layer, and dimensions of each element constituting the via cell.

The automatic placement and routing device 1 is an information processor such as a workstation and a personal computer. The automatic placement and routing device 1 includes a reading/preprocessing unit 6, a main unit 7 and a spare cell verification unit 8, which are computer programs. The automatic placement and routing device 1 and the design database 9 are connected with so as to communicate each other. To simplify the system and/or to save space, both of them may be combined.

The reading/preprocessing unit 6 reads the connection data between terminals of blocks included in the objective LSI from the circuit diagram data file 2. Also, the reading/preprocessing unit 6 reads the artwork data regarding the cell/block used in the objective LSI from the cell/block library 3.

In addition, the reading/preprocessing unit 6 reads design rule data from the design rule file 4. The design rule data are used in the process of placement, routing and verifying, such as the routing pitch, the routing width and the minimum routing pitch of each routing layer, and the dimensions of each element constituting the via cell.

The main unit 7 includes an automatic placement and routing section 7-1 and a spare cell placement section 7-2. The automatic placement and routing section 7-1 generates data for placement and routing based on the read data, and carries out the placement and routing of functional blocks onto a placement and routing area. The functional blocks are to be used directly for realizing the circuit functions. Then, the automatic placement and routing section 7-1 verifies the result of the placement and routing. When defects are detected as a result of the verification, the automatic placement and routing section 7-1 or an input/edit unit (not shown) corrects the defects and carries out the placement and routing again. The verification and the correction are repeated until the defects are fixed. When the defects are fixed, the spare cell placement section 7-2 places spare cells, disregarding the above-mentioned routing result, onto an area with no functional block in the placement and routing area. The spare cell is a spare functional block which is not used directly to realize the circuit function. Then, the spare cell placement section 7-2 outputs the result of the placement and routing.

The spare cell verification unit 8 includes a spare cell design violation verification section 8-1 and a spare cell removal section 8-2. The spare cell design violation verification section 8-1 verifies whether or not the relation ship between the spare cells and the routing is conformable to a design rule described in the design rule data, and whether or not there is any other defect. Then, the spare cell design violation verification section 8-1 detects a design violation spare cell, that is the spare cell with design violation or with any other defect. The spare cell removal section 8-2 removes the design violation spare cell detected by the spare cell design violation verification section 8-1. If the design violation spare cell is not defected, The spare cell removal section 8-2 reconverts the result data of the placement and routing into an artwork data, and then outputs the reconverted data as a placement and routing result output file 5.

Here, an usual verification of placement and routing may be carried out again. As a result, the accuracy of the design is more improved. Also, when some functional block is removed by the further verification, the spare cell placement section 7-2 may carries out the placement of the spare cells, and the spare cell verification unit 8 may verify the spare cells which is newly placed. In this way, much more spare cells can be placed.

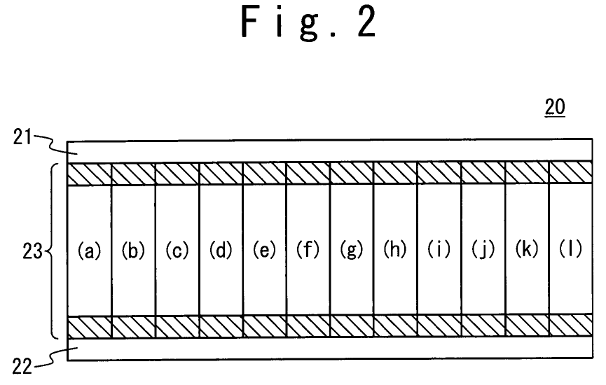

FIG. 2 is a view showing an example of the placement and routing area used in the embodiment of the method of placement and routing of the semiconductor device according to the present invention. A placement and routing area 20 is composed of a power supply interconnection 21, a ground interconnection 22, and a plurality of sites 23 set therebetween, which are denoted by symbols (a) to (1). Each of the sites 23 has the same rectangular shape. The functional blocks are placed in the region where the sites 23 are set. Each of the functional blocks occupies one or more of the sites 23.

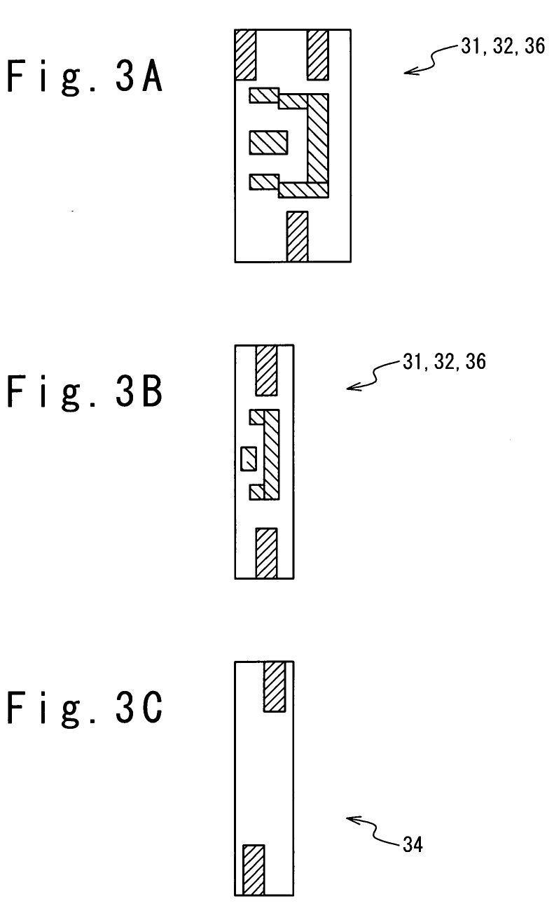

FIGS. 3A, 3B and 3C are pattern diagrams showing examples of the functional blocks. In FIG. 3A, the functional block occupies two of the sites 23. In FIG. 3B and FIG. 3C, the functional blocks occupy one of the sites 23. In FIG. 3A and FIG. 3B, the functional blocks (31, 32, and 36) are exemplified by an AND circuit, a buffer circuit, an inverter circuit, a flip-flop circuit, and so on. These functional blocks are also used as a phantom cell 36, which is a kind of the spare cell. The phantom cells 36 are placed dispersedly in advance, preparing for design change. In FIG. 3C, the functional block (34) is capacitor cell 34, which are exemplified by a fill cell with a gate cap such as a power supply capacitor for power supply noise reduction.

Next, an embodiment of the method of the placement and routing of the semiconductor device (an operation of the automatic placement and routing device) of the present invention will described bellow with reference to attached drawings. Here, the capacitor cells 34 are introduced as the spare cells in this example.

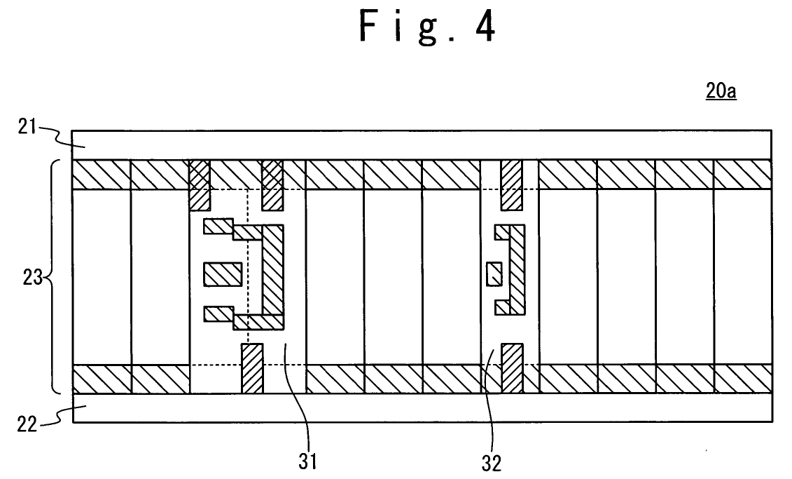

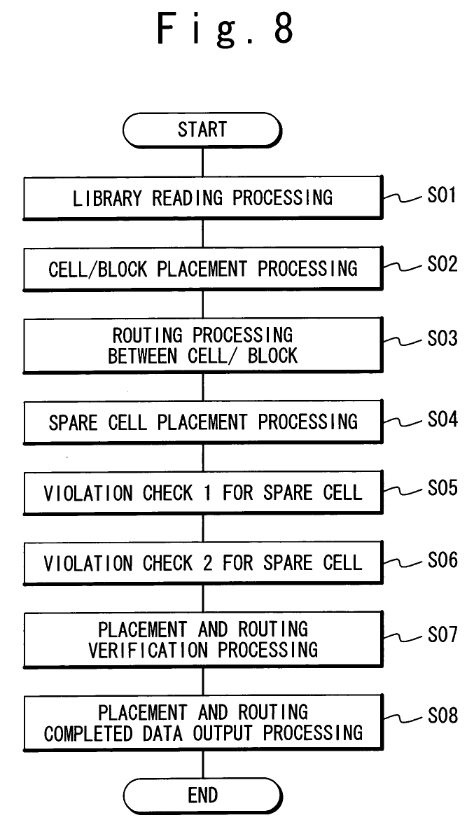

FIG. 8 is a flowchart showing the embodiment of the method of the placement and routing of the semiconductor device according to the present invention. FIGS. 4 to 7 are pattern diagrams showing the states of the placement and routing area 20, each of which corresponds to each of the steps of S02 to S05 in the flowchart in FIG. 8.

(1) Step S01: Library Reading Processing

Referring to FIG. 8, a reading/preprocessing unit 6 reads data from the circuit diagram data file 2, the cell/block library 3 and the design rule file 4. The data are registered beforehand as library data in the design database 9. The data include the circuit diagram data, the functional block data, and the design rule data. The circuit diagram data indicate the circuit diagram and the connection relationships between terminals. The functional block data indicate the functional blocks to be placed. The design rule data indicate the routing pitch, the routing width, the minimum routing space, the via length, the dimensions of elements consisting via cell and the like. Then, the Reading/preprocessing unit 6 sets a placement and routing rule.

(2) Step S02: Cell/Block Placement Processing

The automatic placement and routing section 7-1 automatically places functional blocks in the LSI chip. The functional blocks are described in the circuit diagram. At this time, the placement and routing area 20 in FIG. 2 is changed to be a placement and routing area 20a shown in FIG. 4. In this example, the functional block 31 is placed on the sites (c) and (d), and the functional block 32 is placed on the site (h). Afterwards, the result of the placement is verified. When defects are found, the automatic placement and routing section 7-1 or an input/edit unit (not shown) corrects and carries out the placement again. The verification and the correction are repeated until the defects are fixed.

(3) Step S03: Routing Processing Between Cell/Block

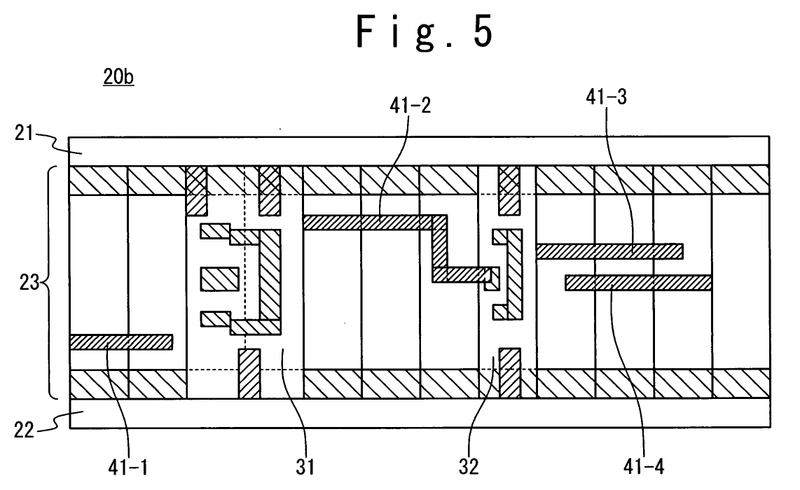

Referring to FIG. 8, the automatic placement and routing section 7-1 automatically carries out routing between the functional blocks based on the determined placement and routing rule. At this time, the placement and routing area 20a in FIG. 4 is changed to be a placement and routing area 20b as shown in FIG. 5. In this example, the routing of interconnections 41-1 to 41-4 are carried out. Afterwards, the result of the routing is verified. When defects are found, the automatic placement and routing section 7-1 or input/edit unit (not shown) corrects the defects and carries out the routing again. The verification and the correction are repeated until the defects are fixed.

(4) Step S04: Spare Cell Placement Processing

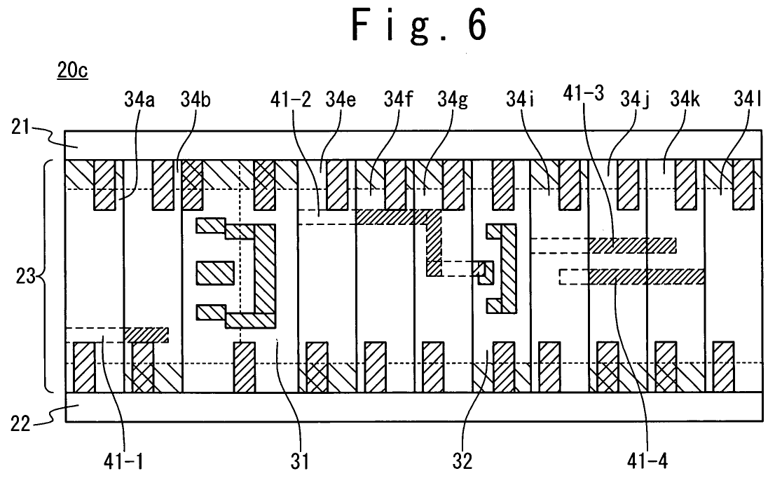

Referring to FIG. 8, the spare cell placement section 7-2 places spare cells, disregarding the above-mentioned routing result, onto areas with no functional block in the placement and routing area, based on the result of the placement and routing with no defect. At this time, the placement and routing area 20b in FIG. 5 is changed to be a placement and routing area 20c as shown in FIG. 6. In this example, the spare cells 34a to 34b, 34e to 34g, and 34i to 341 are placed on the sites (a) to (b), (e) to (g), and (i) to (1) of the sites 23. That is, the spare cell is not placed on the sites (c), (d) and (h) where the functional blocks 31 and 32 are already placed therein.

(5) Step S05: Violation Check 1 for the Spare Cell

Referring to FIG. 8, the spare cell design violation verification section 8-1 in the spare cell verification unit 8 verifies whether or not the relationship between the spare cell and the interconnection (routing) causes a violation of the design rule. Then, the spare cell design violation verification section 8-1 detects the spare cell with violation of the design rule (the violation spare cell). The design rule stored in the design rule file 4 and the rule of the placement and routing can be applied to the above-mentioned design rule. In this example, in the placement and routing area 20c as shown in FIG. 6, the interconnection 41-1 is in contact with the terminals of the spare cells 34a to 34b. Additionally, the interconnection 41-2 is in contact with the terminals of the spare cells 34e to 34g. These contact points are exactly in the design rule violation.

(6) Step S06: Violation Check 2 for the Spare Cell

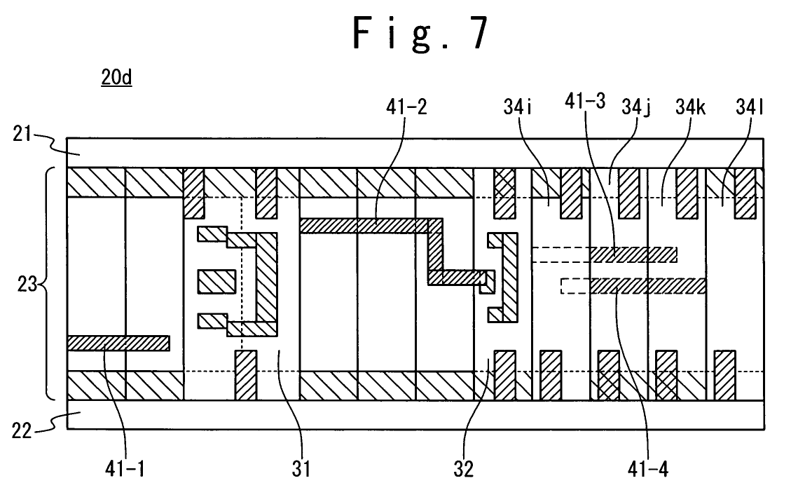

Referring to FIG. 8, the design violation spare cell removal section 8-2 removes the detected design violation spare cells. Here, the placement and routing area 20c in FIG. 6 is changed to be a placement and routing area 20d as shown in FIG. 7. In this example, the above-mentioned spare cells 34a to 34b and 34e to 34g, which are in the design rule violation against the design rule, have been removed.

(7) Step S07: Placement and Routing Verification Processing

Referring to FIG. 8, the spare cell verification unit 8 verifies again whether or not defects such as unplaced blocks, unconnected points and shorted points in the interconnections are found based on the design rules stored in the design rule file 4 and the placement and routing rule. When defects are found, the main unit 7 or the input/edit unit (not shown) belonging to the main unit 7, corrects the defects and carries out the placement and wiring again.

Here, when there are vacant sites or areas such as re-routing sites, the spare cell placement section 7-2 executes the placement of the spare cells (S04), and the spare cell verification unit 8 carries out further verifications of the newly placed spare cells (SO5 and S06). Here, the vacant sites are caused by removing some functional block from the sites in the further verification. The areas such as re-routing sites are caused by executing the further placement and routing.

It should be noted that the placement and routing and the verification are finished at the Step 03, so that the errors are not essentially found. Even if the spare cells are placed at the Step S05, since the spare cells with the design rule violation should be removed at the step S06, errors are not essentially found also in the step 06. Therefore, the step S07 might be omitted.

(8) Step: S08: Placement and Routing Completed Data Output Processing

Referring to FIG. 8, if the defects are not found in the step S07, execution result data of the placement and routing (data of the automatic placement and routing device 10) is reconverted to the artwork data which corresponds to each layer pattern of the LSI. Finally, the reconverted artwork data is outputted as a placement and routing result output file 5.

The processing of the placement and routing are completed by the above-mentioned process.

In the above-mentioned process, the placement of the spare cells is carried out after the routing. Therefore, routing efficiency should be improved in comparison with the conventional placement and routing in which the routing is carried out after the placement of the spare cells. Additionally, it is not necessary for the routing to be in consideration of the position of a numerous number of spare cells. It contributes the reduction of load of routing tools and the memory capacity required for designing. This causes the reduction of the TAT for designing in the automatic placement and routing device. Therefore, the efficiency of designing the semiconductor device can be improved.

It is not necessary to place the spare cells fully onto the whole possible area in the placement and routing area. Even if the spare cells with design rule violation at the step S05 has been removed, the design efficiency and quality should not be affected. The number of the spare cells actually removed is less than or equal to 10% of whole spare cells even though it depends on the design.

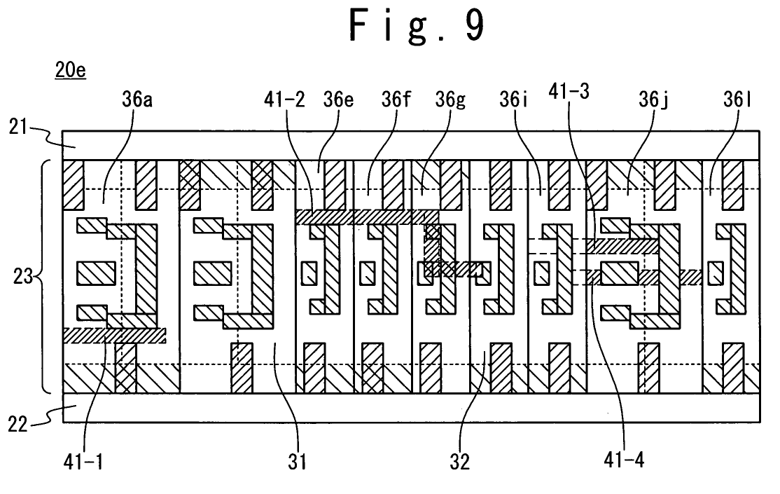

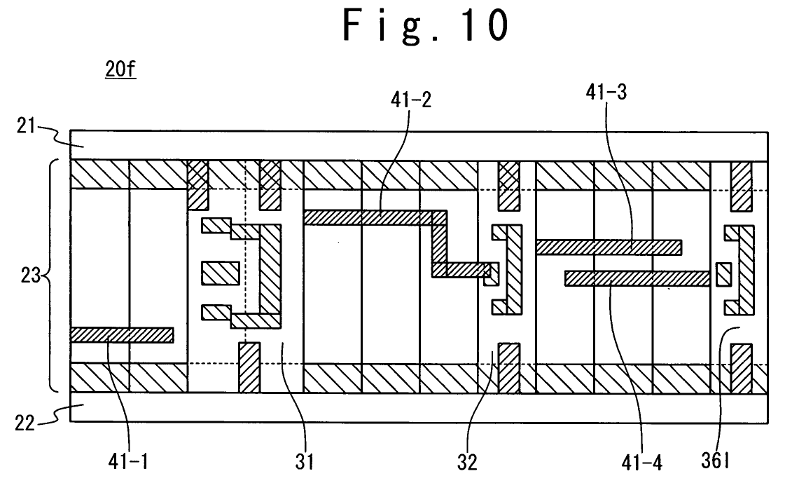

In another embodiment of the present invention, a phantom cell (36) can be used as a spare cell. FIGS. 9 to 10 are pattern diagrams showing the states of the placement and routing area 20, each of which corresponds to each of the steps of S04 to S05 in the flowchart in FIG. 8. The description of the steps S01 to S03, S07 and S08 in FIG. 8 are omitted because the operation using the phantom cell is the same as that using the capacitor cell as the spare cell.

(4) Step S04: Spare Cell Placement Processing

Referring to FIG. 8, the spare cell placement section 7-2 places spare cells, disregarding the above-mentioned routing result, onto areas with no functional block in the placement and routing area, based on the result of the placement and routing with no defect. At this time, the placement and routing area 20b in FIG. 5 is changed to be a placement and routing area 20e as shown in FIG. 9. In this example, the spare cells 36a, 36e to 34g, 36i to 36j and 361 are placed on sites (a) to (b), (e) to (g), and (i) to (1) of the sites 23. That is, the spare cell is not placed on the sites (c), (d) and (h) where the functional blocks 31 and 32 are already placed therein.

(5) Step S05: Violation Check 1 for the Spare Cell

Referring to FIG. 8, the spare cell design violation verification section 8-1 in the spare cell verification unit 8 verifies whether or not the relationship between the spare cell and the interconnection (routing) causes a violation of the design rule. Then, the spare cell design violation verification section 8-1 detects the spare cell with violation of the design rule (the violation spare cell) The design rule stored in the design rule file 4 and the rule of the placement and routing can be applied to the above-mentioned design rule. In this example, in the placement and routing area 20e as shown in FIG. 9, the interconnection 41-1 is in contact with the terminals of the spare cell 36a. Additionally, the interconnection 41-2 is in contact with the terminals of the spare cells 36e to 36g. Furthermore, the interconnections 41-3, 41-4 are in contact with the terminals of the spare cells 36i to 36j. These contact points are exactly in the design rule violation.

(6) Step S06: Violation Check 2 for the Spare Cell

Referring to FIG. 8, the design violation spare cell removal section 8-2 removes the detected design violation spare cells. Here, the placement and routing area 20e in FIG. 9 is changed to be a placement and routing area 20f as shown in FIG. 10. In this example, the above-mentioned spare cells 36a, 36e to 36g and 34i to 34j, which are in the design rule violation against the design rule, have been removed.

The above-mentioned process can obtained the effects same as those of the process using the capacitor cells.

The load to routing tools is reduced by the step S07 in which the above-mentioned steps S04 to S06 are carried out again after the verification. Also, much more capacitor cells or the Phantom cells can be introduced, relatively in short time, onto the vacant sites which does not affect the placement after the correction of the defects. As a result, it becomes easy to reduce the power supply noise and to handle the design change.

Hereinafter, the embodiment of the manufacturing method of the semiconductor device of the present invention will be described bellow with reference to the attached drawing. In the manufacturing method, a layout of the semiconductor device is formed by the above-mentioned method of placement and routing of the semiconductor device of the present invention.

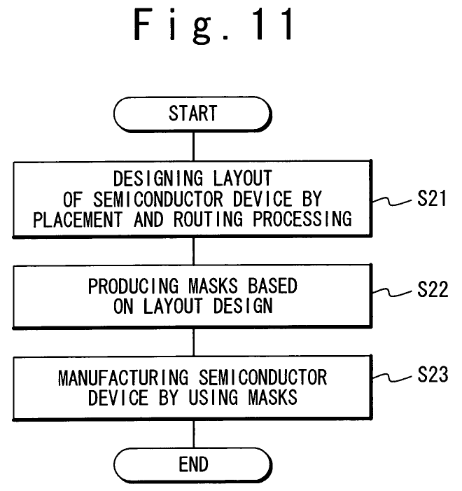

FIG. 11 is a flowchart showing the embodiment of the manufacturing method of the semiconductor device according to the present invention.

(1) Step S21

The placement and routing result output file 5 can be obtained by the above-mentioned steps S01 to S08. That is, the layout design of the semiconductor device is completed by the placement and routing processing of the semiconductor device.

(2) Step S22

Masks used for the manufacturing method of the semiconductor device is designed based on the layout design in the step S21. The masks are produced based on the design. There are no limitation of a designing method or a mask producing method, for instance, well-known conventional technique may be used.

(3) Step S23

The semiconductor device is manufactured on a semiconductor substrate by using the masks produced at the step S22. The only limitation of the manufacturing process is to use the above-mentioned masks for the semiconductor device. For instance, the well-known conventional deposition processing and the lithography processing and so on, can be used.

The semiconductor device of the present invention can be manufactured through the step S21 to S23. Also in this case, a placement of the spare cells is carried out after routing. Therefore routing efficiency should be improved in comparison with the placement and routing by prior arts in which the placement and wiring is carried out in reverse order.

Additionally, the calculation time for the automatic routing is shortened, as a result, the design TAT is shortened. Therefore, the processing time from the design to manufacturing of the semiconductor device can be reduced.

According to the present invention, spare cells can be placed while reducing the load of routing tools and the memory capacity required for designing. Also, the most appropriate routing can be executed while not being affected by spare cells. Furthermore, an efficiency of designing of a semiconductor device can be improved.

1. A method of placement and routing of a semiconductor device, comprising:
(a) executing placement of functional blocks and executing routing of interconnections in a placement and routing area of a semiconductor device based on circuit diagram data, functional block data and design rule data;
(b) executing placement of spare cells in first areas of said placement and routing area, disregarding said routing result, wherein said functional blocks are not placed in said first areas, said spare cells are spare functional blocks; and
(c) removing first spare cells of said spare cells from said first areas, wherein said first spare cells are in violation of a design rule with regard to a relation to said interconnections, said design rule is described in said design rule data.

2. The method of placement and routing of a semiconductor device according to claim 1, wherein said spare cells includes at least one of a fill cell and a phantom cell.

3. The method of placement and routing of a semiconductor device according to claim 1, further comprising:
(d) verifying a situation of said placement and routing area based on said circuit diagram data, said functional block data and said design rule data;
(e) executing corrections of defects in second areas of said placement and routing area, when said defects are found in said second areas during said verification;
(f) re-executing placement of other functional blocks and re-executing routing of other interconnections in said second areas;
(g) executing placement of other spare cells in third areas of said second areas, disregarding said re-executed routing result, wherein said other functional blocks are not placed in said third areas, said other spare cells are spare functional blocks; and
(h) removing second spare cells of said other spare cells from said third areas, wherein said second spare cells are in violation of said design rule with regard to a relation to said other interconnections.

4. The method of placement and routing of a semiconductor device according to claim 2, further comprising:
(d) verifying a situation of said placement and routing area based on said circuit diagram data, said functional block data and said design rule data;
(e) executing corrections of defects in second areas of said placement and routing area, when said defects are found in said second areas during said verification;
(f) re-executing placement of other functional blocks and re-executing routing of other interconnections in said second areas;
(g) executing placement of other spare cells in third areas of said second areas, disregarding said re-executed routing result, wherein said other functional blocks are not placed in said third areas, said other spare cells are spare functional blocks; and
(h) removing second spare cells of said other spare cells from said third areas, wherein said second spare cells are in violation of said design rule with regard to a relation to said other interconnections.

5. An automatic placement and routing device comprising:
an automatic placement and routing section which executes placement of functional blocks and executes routing of interconnections in a placement and routing area of a semiconductor device based on circuit diagram data, functional block data and design rule data;
a spare cell placement section which executes placement of spare cells in first areas of said placement and routing area, disregarding said routing result, wherein said functional blocks are not placed in said first areas, said spare cells are spare functional blocks; and
a spare cell verification section which removes first spare cells of said spare cells from said first areas, wherein said first spare cells are in violation of a design rule with regard to a relation to said interconnections, said design rule is described in said design rule data.

6. The automatic placement and routing device according to claim 5, wherein said spare cells includes at least one of a fill cell and a phantom cell.

7. The automatic placement and routing device according to claim 5, wherein said spare cell verification section verifies a situation of said placement and routing area based on said circuit diagram data, said functional block data and said design rule data,
said spare cell verification section executes corrections of defects in second areas of said placement and routing area, when said defects are found in said second areas during said verification,
said spare cell verification section re-executes placement of other functional blocks and re-executes routing of other interconnections in said second areas,
said spare cell placement section executes placement of other spare cells in third areas of said second areas, disregarding said re-executed routing result, wherein said other functional blocks are not placed in said third areas, said other spare cells are spare functional blocks, and
said spare cell verification section removes second spare cells of said other spare cells from said third areas, wherein said second spare cells are in violation of said design rule with regard to a relation to said other interconnections.

8. The automatic placement and routing device according to claim 6, wherein said spare cell verification section verifies a situation of said placement and routing area based on said circuit diagram data, said functional block data and said design rule data,
said spare cell verification section executes corrections of defects in second areas of said placement and routing area, when said defects are found in said second areas during said verification,
said spare cell verification section re-executes placement of other functional blocks and re-executes routing of other interconnections in said second areas,
said spare cell placement section executes placement of other spare cells in third areas of said second areas, disregarding said re-executed routing result, wherein said other functional blocks are not placed in said third areas, said other spare cells are spare functional blocks, and
said spare cell verification section removes second spare cells of said other spare cells from said third areas, wherein said second spare cells are in violation of said design rule with regard to a relation to said other interconnections.

9. A computer program product embodied on a computer-readable medium and comprising code that, when executed, causes a computer to perform the following:
(a) executing placement of functional blocks and executing routing of interconnections in a placement and routing area of a semiconductor device based on circuit diagram data, functional block data and design rule data;
(b) executing placement of spare cells in first areas of said placement and routing area, disregarding said routing result, wherein said functional blocks are not placed in said first areas, said spare cells are spare functional blocks; and
(c) removing first spare cells of said spare cells from said first areas, wherein said first spare cells are in violation of a design rule with regard to a relation to said interconnections, said design rule is described in said design rule data.

10. The computer program product according to claim 9, wherein said spare cells includes at least one of a fill cell and a phantom cell.

11. The computer program product according to claim 9, further comprising:
(d) verifying a situation of said placement and routing area based on said circuit diagram data, said functional block data and said design rule data;
(e) executing corrections of defects in second areas of said placement and routing area, when said defects are found in said second areas during said verification;
(f) re-executing placement of other functional blocks and re-executing routing of other interconnections in said second areas;
(g) executing placement of other spare cells in third areas of said second areas, disregarding said re-executed routing result, wherein said other functional blocks are not placed in said third areas, said other spare cells are spare functional blocks; and
(h) removing second spare cells of said other spare cells from said third areas, wherein said second spare cells are in violation of said design rule with regard to a relation to said other interconnections.

12. The computer program product according to claim 10, further comprising:
(d) verifying a situation of said placement and routing area based on said circuit diagram data, said functional block data and said design rule data;
(e) executing corrections of defects in second areas of said placement and routing area, when said defects are found in said second areas during said verification;
(f) re-executing placement of other functional blocks and re-executing routing of other interconnections in said second areas;
(g) executing placement of other spare cells in third areas of said second areas, disregarding said re-executed routing result, wherein said other functional blocks are not placed in said third areas, said other spare cells are spare functional blocks; and
(h) removing second spare cells of said other spare cells from said third areas, wherein said second spare cells are in violation of said design rule with regard to a relation to said other interconnections.

13. A manufacturing method of a semiconductor device, comprising:
(a) obtaining a layout design of a semiconductor device by a method of placement and routing of said semiconductor device; and
(b) manufacturing said semiconductor device by using masks produced by using said layout design, wherein said method of placement and routing of said semiconductor device, including:
(a1) executing placement of functional blocks and executing routing of interconnections in a placement and routing area of a semiconductor device based on circuit diagram data, functional block data and design rule data;
(a2) executing placement of spare cells in first areas of said placement and routing area, disregarding said routing result, wherein said functional blocks are not placed in said first areas, said spare cells are spare functional blocks; and
(a3) removing first spare cells of said spare cells from said first areas, wherein said first spare cells are in violation of a design rule with regard to a relation to said interconnections, said design rule is described in said design rule data.

14. The manufacturing method of a semiconductor device according to claim 13, wherein said spare cells includes at least one of a fill cell and a phantom cell.

15. The manufacturing method of a semiconductor device according to claim 13, wherein said method of placement and routing of said semiconductor device, further including:
(a4) verifying a situation of said placement and routing area based on said circuit diagram data, said functional block data and said design rule data;
(a5) executing corrections of defects in second areas of said placement and routing area, when said defects are found in said second areas during said verification;
(a6) re-executing placement of other functional blocks and re-executing routing of other interconnections in said second areas;
(a7) executing placement of other spare cells in third areas of said second areas, disregarding said re-executed routing result, wherein said other functional blocks are not placed in said third areas, said other spare cells are spare functional blocks; and
(a8) removing second spare cells of said other spare cells from said third areas, wherein said second spare cells are in violation of said design rule with regard to a relation to said other interconnections.

16. The manufacturing method of a semiconductor device according to claim 14, wherein said method of placement and routing of said semiconductor device, further including:
(a4) verifying a situation of said placement and routing area based on said circuit diagram data, said functional block data and said design rule data;
(a5) executing corrections of defects in second areas of said placement and routing area, when said defects are found in said second areas during said verification;
(a6) re-executing placement of other functional blocks and re-executing routing of other interconnections in said second areas;
(a7) executing placement of other spare cells in third areas of said second areas, disregarding said re-executed routing result, wherein said other functional blocks are not placed in said third areas, said other spare cells are spare functional blocks; and
(a8) removing second spare cells of said other spare cells from said third areas, wherein said second spare cells are in violation of said design rule with regard to a relation to said other interconnections.
